(19) United States
(12) Patent Application Publication
(10) Pub. No.: US 2013/0046428 A1
(43) Pub. Date: Feb. 21, 2013

(54) ENERGY MANAGEMENT DEVICE FOR AT LEAST ONE ELECTRICAL ENERGY CONSUMER OF A VEHICLE

(71) Applicant: Frank JORDAN, Ruesselsheim (DE)

(72) Inventor: Frank JORDAN, Ruesselsheim (DE)

(73) Assignee: GM GLOBAL TECHNOLOGY OPERATIONS LLC, Detroit, MI (US)

(21) Appl. No.: 13/589,295

(22) Filed: Aug. 20, 2012

(30) Foreign Application Priority Data
Aug. 20, 2011 (DE) 10 2011 111 211.5

(51) Int. Cl. G06F 17/00; B60W 20/00; B60W 10/30; G01C 21/00

(52) U.S. Cl. 701/22; 701/36

(57) ABSTRACT

An energy management device is provided for at least one energy consumer of a vehicle, which includes, but is not limited to a receiver designed to receive data from a navigation system, an evaluator designed on the one hand to determine a traveling time for the vehicle to reach a predetermined destination based on the received data of the navigation system, and on the other to determine a deactivation time based on the traveling time for switching off the at least one energy consumer before the traveling time has expired, and an actuator designed to switch off the at least one energy consumer at the deactivation time before the traveling time has expired.

### CROSS-REFERENCE TO RELATED APPLICATION

This application claims priority to German Patent Application No. 10 2011 111 211.5, filed Aug. 20, 2011, which is incorporated herein by reference in its entirety.

### TECHNICAL FIELD

The technical field relates to an energy management device for at least one electrical energy consumer of a vehicle, in particular a motor vehicle.

### BACKGROUND

DE 10 2008 021 045 A1 describes a system for a driving route-dependent energy management system. During a prolonged uphill drive, the power of the air conditioner is reduced by a fixed percentage. This makes it possible to convert a larger percentage of electrical energy into driving energy for an uphill drive lasting for a pre-calculated period, or also to keep it available for subsequent legs of the journey. If less driving energy is later needed, e.g., because a downhill drive has begun, the power of the air conditioner can be increased once again, for example.

Against this backdrop, the object of the present invention is to provide an improved energy management device for energy consumers of a vehicle. In addition, other objects, desirable features and characteristics will become apparent from the subsequent summary and detailed description, and the appended claims, taken in conjunction with the accompanying drawings and this background.

### SUMMARY

An energy management system for at least one electrical energy consumer of a vehicle, that includes, but is not limited to a receiver designed to record position data of the vehicle and other route data about the anticipated route progression for the vehicle to a predetermined destination using an onboard navigation system, an evaluator designed to calculate the traveling time it will take the vehicle to reach a predetermined destination based on the recorded position data and route data, and, based on the calculated traveling time, calculate a deactivation time for switching off the at least one energy consumer before the calculated traveling time has expired, an actuator designed to switch off the at least one energy consumer at the calculated deactivation time. A motor vehicle is also provided with a navigation system having at least one energy consumer and the energy management device.

A method is provided for switching off at least one energy consumer of a vehicle, including, but not limited to recording position data of the vehicle and other route data about the anticipated route progression of the vehicle to a predetermined destination using an onboard navigation system, calculating a traveling time it will take the vehicle to reach the predetermined destination based on the recorded position data and route data, calculating a deactivation time for switching off the at least one energy consumer before the calculated traveling time has expired based on the calculated traveling time, switching off the at least one energy consumer at the calculated deactivation time.

Switching off energy consumers is beneficial, for example an interior heater, before reaching a prescribed destination of the vehicle, and using the follow-up time or response time of the energy consumer. Such electrical energy consumers, such as heaters, require a follow-up time or response time until they respond, i.e., have been cooled off completely as the result of deactivation, for example.

At least one advantage to the energy management device is that it already switches off the energy consumer before a prescribed destination has been reached, and that the energy consumer is not switched off only once the vehicle has reached its destination and the vehicle ignition has been turned off. The consumption of energy and fuel can be reduced as a result.

In an embodiment, the energy management device or its evaluator determines the deactivation time based on at least one other parameter. For example, the parameter is the response time or follow-up time of the energy consumer, the sunlight incident on the vehicle, the interior temperature of the vehicle, the outside temperature of the vehicle, the occurrence of rain or the actual state of the energy consumer. As a result, additional aspects can be considered that may make it appear expedient to use the respective energy consumer for a longer or shorter period, so that a deactivation time can be correspondingly adjusted to ensure the level of comfort produced by the energy consumer for a vehicle passenger. For example, given exposure to strong sunlight, and a resultant warming of the vehicle interior, the deactivation time for the cooling unit of an air conditioner as the energy consumer can be shortened accordingly, so that the latter is only switched off at a later point.

In another embodiment, the evaluator for determining the at least one other parameter is coupled, for example, with at least one light sensor, an interior temperature sensor, an outside temperature sensor, a rain sensor, a windshield wiper system and/or a temperature sensor in order to determine the actual temperature of the energy consumer. These types of sensors along with the windshield wiper system are usually already present in the vehicle, so that the energy management device and its evaluator can draw upon the results obtained by these sensors, as well as the respective operating state of the windshield wiper system, so as to determine a suitable deactivation time for the allocated energy consumer. As a consequence, no extra sensors need be added, making it possible to save on additional costs.

In another embodiment, the deactivation time is stored in a memory device, and can be called by means of the evaluator, wherein the memory device is part of the energy management system or coupled to the latter, for example. Storing a deactivation time or at least an equation for calculating the deactivation time in the memory device allows the evaluator to very easily determine a suitable deactivation time for the energy consumer.

In another embodiment, the evaluator determines whether the vehicle will be delayed in reaching its predetermined destination by means of the navigation system, for example by acquiring a delay timeframe within which the vehicle will arrive late at its destination or a delay time required by the vehicle to arrive late at the predetermined destination. When the vehicle reaches the destination later than calculated beforehand, for example as the result of a traffic jam, the delay can be taken into account accordingly when determining the deactivation time, so that the energy consumer is not switched off too early.

In another embodiment, the actuator reactivates the at least one energy consumer that had previously been switched off, or the evaluator determines a new deactivation time for the at least one switched on energy consumer, based on the delay of the vehicle as determined by the navigation system. Reactivating the energy consumer or determining a new deactivation time for an energy consumer which is still switched on results in loss in comfort for the vehicle passenger.

In an embodiment of the motor vehicle, the energy consumer is designed as a seat heater, a seat cooler, a window heater, a steering wheel heater, an air conditioner, in particular an interior heater, an interior cooler or a ventilation fan. In an embodiment, the motor vehicle is designed as a hybrid vehicle, an electric vehicle, a gas-powered vehicle, a fuel-cell vehicle and/or a vehicle with an internal combustion engine.

The above embodiments and further developments can be combined as desired, if expedient. Additional potential embodiments, further developments and implementations of the invention also encompass those combinations of features of the embodiments described previously or below in relation to the embodiments that have not been explicitly mentioned. In particular, the expert will also add individual aspects as improvements or enhancements to the respective original form of the embodiments.

### BRIEF DESCRIPTION OF THE DRAWINGS

The present invention will hereinafter be described in conjunction with the following drawing figures, wherein like numerals denote like elements, and:

FIG. 1 is a schematic view of an energy management device for shutting off several energy consumers of a vehicle according to an embodiment of the invention; and

FIG. 2 is a timeline that shows the driving time for a vehicle to a prescribed destination and deactivation times tE for two energy consumers; and

FIG. 3 is a sequence diagram for actuating energy consumers according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

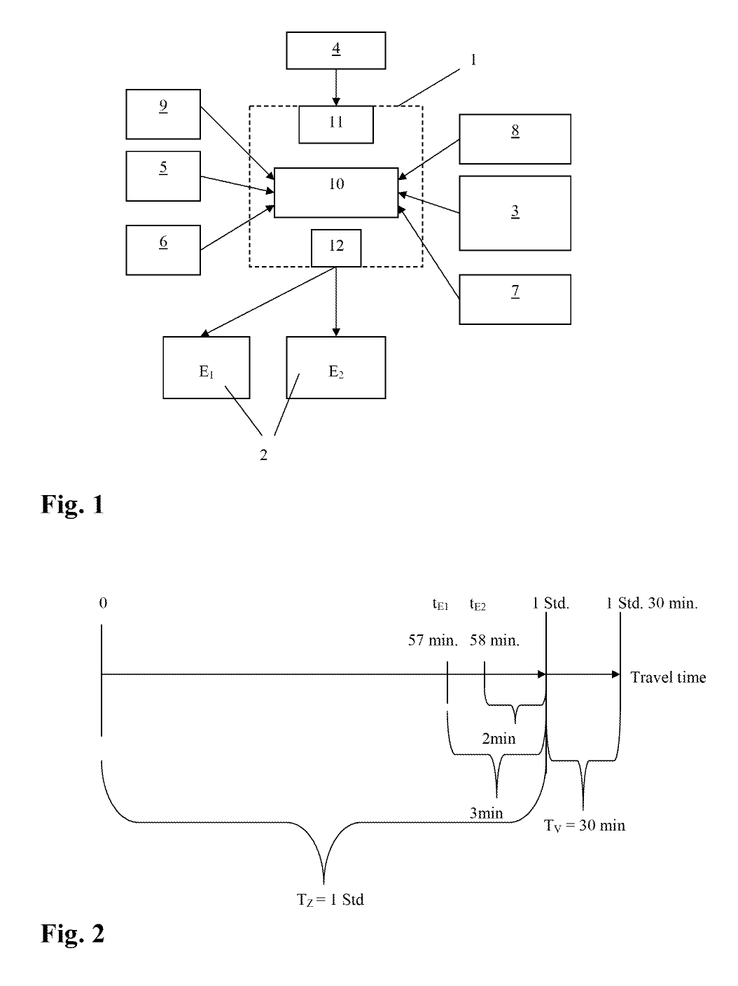

FIG. 1 presents a schematic view of an energy management device 1, shown for shutting off at least one or more energy consumers (E1, E2) 2, etc., of a vehicle according to an embodiment. Further depicted on the accompanying FIG. 2 is an example for a timeline that shows a traveling time TZ for the vehicle to a prescribed destination and deactivation times tE for two energy consumers E1, E2.

Energy consumers 2 in the vehicle are generally those units E1, E2 that consume energy, and exhibit a follow-up time or response time during deactivation. In particular, energy consumers 2 such as these in a vehicle involve comfort-enhancing units, for example a seat heater, a window heater, e.g., for heating a rear window, a steering wheel heater, air conditioners, e.g., an interior heater and/or an interior cooler, a ventilator, etc. When this type of energy consumer 2 is turned off, for example an interior heater, it takes a certain time interval, or follow-up or response time, before the interior heater has cooled down completely. Given a ventilator as the energy consumer 2, it takes a specific time interval or response time before a fan of the energy consumer 2, which in this example is a ventilator, has come to a halt.

According to an embodiment, such an energy consumer 2 is switched off before a vehicle reaches its destination, and not once the destination has been reached and the vehicle ignition has been turned off, as had been the case previously. The fuel and energy consumption can be reduced. The embodiments are geared toward vehicles, in particular motor vehicles, for example electric vehicles, hybrid vehicles, fuel-cell vehicles, gas-powered vehicles, vehicles with an internal combustion engine (e.g., gas engine or diesel engine), etc., or vehicles with a combination of at least two of the mentioned vehicle drives.

As depicted in the exemplary embodiment on FIG. 1 and FIG. 2, the energy management device 1 for activating at least one energy consumer exhibits a receiver 10 to receive data from a navigation system 3 and, for example, two energy consumers E1 and E2 of a vehicle. In addition, the energy management device exhibits an evaluator 11 to evaluate the data from the navigation system 3 and energy consumers (E1, E2) 2, as well as an actuator 12 for activating or switching on and off the two energy consumers (E1, E2) 2 independently of the result obtained by the evaluator 11. The evaluator 11 determines whether the respective energy consumer 2 is switched on, and also uses the data obtained from the navigation system 3 of the vehicle to determine the driving time TZ after which the vehicle will have reached a prescribed destination, for example TZ=1 hour.

As an option, the evaluator 11 can also determine whether the vehicle will be late, for example if the receiver 10 receives word from the navigation system 3 that the vehicle will be delayed in arriving at its destination, e.g., as the result of a traffic jam or altered course of the vehicle. Based on the data obtained by the navigation system 3, the evaluator 11 determines a delay timeframe TV, e.g., TV=0.5 hours, by which the vehicle will be delayed and/or a delay time TZ+V=TZ+TV, e.g., 1.5 hours=1 hour+0.5 hours, required by the vehicle to arrive at the prescribed destination.

Depending on the driving time TZ or a potential delay time TZ+V and/or a delay timeframe TV, the evaluator 11 determines a deactivation time tE after which the actuator 12 switches off a respectively activated energy consumer 2 before reaching the destination. Therefore, the energy management device 1 or its actuator 12 switches off a respective energy consumer 2 after a predetermined deactivation time tE, before the vehicle has reached its prescribed destination, e.g., after a driving time of TZ=1 hour, or after a delay time TZ+V=1.5 hours. The energy consumer 2 can here be switched off by having the actuator 12 completely switch off the energy consumer 2 immediately or instantaneously at the deactivation time tE, or by having the actuator 12 power down the energy consumer 2 starting at the deactivation time tE. The actuator 12 can perform the powering down process either continuously or discontinuously.

For example, the actuator 12 of the energy management device 1 as denoted on FIG. 2 switches off a first power consumer E1 after a predetermined deactivation time tE1, e.g., tE1=3 minutes, before the destination is reached after time TZ, e.g., TZ=1 hour. Accordingly, the actuator switches off a second energy consumer E2 after a predetermined deactivation time tE2, e.g., tE2=2 minutes, before the destination is reached after time TZ, e.g., TZ=1 hour. In other words, the actuator 12 of the energy management device 1 switches off energy consumer E1 after a driving time of 57 minutes, and energy consumer E2 after a driving time of 58 minutes. During the drive, if the evaluator 11 additionally determines via the navigation system 3 that the vehicle is running late by a delay timeframe TV, e.g., TV=0.5 hours, and thus will only reach the prescribed destination after a delay time TZ+V=TZ+TV, the actuator 12 will correspondingly switch off the energy consumer E1 after the deactivation time tE1, e.g., tE1=3 minutes, before the prescribed destination is belatedly reached after time TZ+V, e.g., TZ+V=1.5 hours, i.e., here after 1 hour and 27 minutes.

The predetermined deactivation time tE1 or tE2 can here be determined by the evaluator 11 based on at least one parameter, for example a parameter for the respective energy consumer 2, e.g., the follow-up time or response time of the energy consumer. Additionally or alternatively to the follow-up time or response time of the energy consumer 2, the deactivation time tE can also be determined as a function of at least one parameter, e.g., the interior temperature of the vehicle, the exposure to sunlight, the outside temperature of the vehicle, the occurrence of rain, the state of the energy consumer, etc., as will be explained in more detail below. To this end, the receiver 10 can also be designed in such a way that, in addition to data from the navigation system 3 and energy consumers 2, it also receives data from at least one other sensor, e.g., a temperature sensor, a rain sensor, etc.

For example, the first energy consumer E1 is an interior heater with a follow-up time of 5 minutes, for example, before it is cooled from a maximum temperature down to an initial temperature. Within the follow-up time of 5 minutes, for example, the interior heater is hence cooled off, e.g., completely. The predetermined deactivation time tE1 can now be selected in such a way, for example, as to partially or completely cool off the interior heater after deactivation time tE1, if the vehicle has arrived at the destination after the previously determined time TZ, e.g., TZ=1 hour. For example, the deactivation time tE1 of the interior heater can be selected in such a way as to only cool the interior heater, and thus cause the temperature in the vehicle interior to diminish, to such an extent that the cooling of the interior upon reaching the destination is hardly noticed by a vehicle passenger, if at all. Therefore, the deactivation time tE of an energy consumer 2 is selected in particular by the evaluator in such a way that energy can be economized on the one hand by switching off the energy consumer 2 before a destination has been reached, and on the other by not having the process of switching off the energy consumer 2 lead to any loss in comfort for a vehicle passenger or impair the safety of the vehicle passenger.

The deactivation time tE for the respective energy consumer En (n=1, 2, . . . ) can be stored in advance in a memory device 4, and be called from the memory device 4 by means of the evaluator 11. The memory device 4 can here be part of the energy management device 1 or be coupled with the latter. Aside from the parameter for the respective energy consumer 2, e.g., the follow-up time or response time of the energy consumer 2, the evaluator 11 can additionally or alternatively consider at least one other parameter for determining the deactivation time tE of the respective energy consumer 2.

As described above, this parameter can be the interior temperature of the vehicle or the temperature in the passenger compartment, the exposure to sunlight, the outside temperature of the vehicle, the occurrence of rain, the state of the energy consumer, etc. The invention is not limited to the mentioned examples. The state of the energy consumer 2 here indicates whether the energy consumer 2, for example a heater, has already reached its desired temperature, or is still being heated to the desired temperature. If the heater has not yet reached the desired temperature, the energy management device 1 does not switch off the heater, for example. Only once the heater has reached its desired temperature can the deactivation time tE be determined and adjusted by the energy management device 1, for example.

As an alternative, the deactivation time tE can be adjusted, for example according to the actual temperature of the heater. To this end, a deactivation time tE shortened or lengthened based on an achieved actual temperature can be stored in advance in the memory device, and called by the evaluator to set the deactivation time tE. To determine the interior temperature, the energy management device 1 or its receiver 10 can be coupled with at least one temperature sensor 5, which ascertains the actual temperature in the vehicle interior, as depicted on FIG. 1. The receiver can also use at least one rain sensor 6, for example, to determine whether the vehicle is additionally being cooled off, e.g., by rain, a windshield wiper system 7 to determine the operating state of the windshield wiper system, and hence the occurrence of rain, a light sensor 8 to determine the exposure of the vehicle to sunlight, and hence a warming of the vehicle by exposure to sunlight, an outside temperature sensor 9 to determine the outside temperature of the vehicle, and hence an additional cooling or warming of the vehicle, a temperature sensor that determines the actual temperature of a heater, e.g., the interior heater or interior cooler.

Depending on the acquired interior temperature, the acquired occurrence of rain by the rain sensor 6 and/or the operating state of the windshield wiper system 7 (e.g., interval wiper operation due to rain or idling position due to dryness, etc.), the exposure to sunlight, the outside temperature, and the actual temperature of a heater, the evaluator can determine whether the deactivation time tE of an energy consumer 2 will be set or not, or alternatively adjust the deactivation time tE based on the acquired parameter. To this end, the deactivation time tE can be stored in advance in the memory device 4 as a function of the respective parameter, in such a way that it can be called by the evaluator 11.

The advantage to taking into account these parameters, which also have a direct or indirect effect on the performance or power consumption of an energy consumer 2, is that the deactivation time tE can be additionally optimized. For example, an energy consumer 2, such as a cooler comprising part of an air conditioner for cooling the interior, cannot be switched off by the actuator if the evaluator 11 has determined that the vehicle is additionally being heated by exposure to sunlight, and switching off the cooler would thus be uncomfortable for a vehicle passenger. As an alternative, the energy management device 1 can in this case also set the deactivation time tE based on the parameter, here the determined exposure to sunlight, and select a deactivation time tE shortened or lengthened according to the exposure to sunlight, for example which is stored in the memory device 4.

As described above, the evaluator 11 can optionally additionally or alternatively consider a delay timeframe TV, and hence a delay time TZ+V, as an additional parameter as well, thereby preventing an energy consumer 2 from being switched off too early by the actuator 12, since the vehicle will reach its destination later, e.g., as the result of a detour or traffic jam. The evaluator 11 can use the navigation system 3 coupled therewith to arrive at a delay forecast (driving profile), i.e., e.g., the delay timeframe TV and delay time TZ+V, as denoted on FIGS. 1 and 2.

In addition, the actuator 12 of the energy management device 1 can if need be optionally also reactivate or activate the energy consumer 2, for example if, following the deactivation of the energy consumer 2 at time tE, the evaluator 11 determines that an unexpected delay will arise with a delay timeframe TV, or the evaluator 11 determines, for example by means of the rain sensor 6 or the operating state of the windshield wiper system 7, that the vehicle is passing through a heavy rain, and thus being cooled rapidly. In this case, the actuator 12 reactivates the interior heater that had previously been switched off at time tE, for example.

In so doing, the evaluator 11 determines whether the respective energy consumer 2 is switched on or off. To this end, the receiver can receive data from the respective energy consumer 2, based on which the evaluator 11 determines whether the energy consumer 2 is switched on or off. If the evaluator 11 determines that the energy consumer 2 is switched off, and also that the vehicle will be late in arriving at its destination, for example, the evaluator 11 can ascertain that the actuator 12 will initially reactivate the energy consumer 2, and later deactivate it once again at a newly determined activation time tE as a function of the vehicle delay, before the vehicle has finally arrived late at its destination.

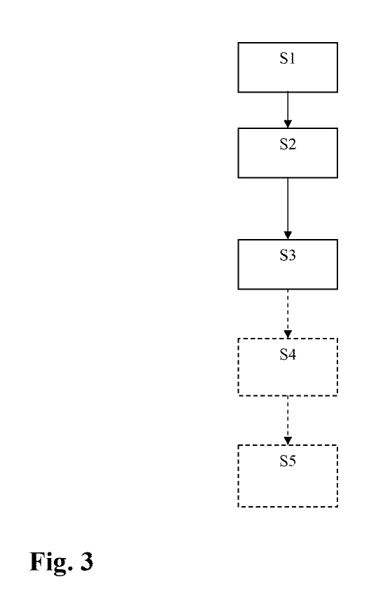

FIG. 3 shows an exemplary embodiment of a sequence diagram for the activation of energy consumers by means of an energy management device according to one embodiment. In a first step S1, the evaluator uses the data from the navigation system of a vehicle received by the receivers to determine a driving time TZ after which the vehicle will have reached a prescribed destination. In step S2, the evaluator subsequently determines whether an energy consumer is switched on, and if so, ascertains the deactivation time tE of the energy consumer at which the energy consumer must be switched off before the destination has been reached.

In step S3, the energy consumer is switched off by the actuator at time tE, i.e., switched off immediately or powered down. In an optional step S4, the evaluator checks whether or not the energy consumer has to be switched on or activated again, e.g., because the vehicle is running late and/or due to some other circumstance, such as heavy rain, strong exposure to sunlight, etc.

Embodiments for determining the deactivation time tE make it possible, in step S3, to take into account at least one or several parameters, such as the follow-up time of the energy consumer, the exposure to sunlight, the interior temperature of the vehicle or the temperature inside the passenger compartment, the outside temperature of the vehicle, the occurrence of rain, the state of the energy consumer, etc., and for the evaluator to determine a deactivation time tE dependent thereon for the energy consumer, e.g., by calling it from a memory device or through calculation.

The embodiments are not limited to the mentioned energy consumers, in particular to the mentioned comfort-enhancing units. In addition, the embodiments also not limited to the step sequence and steps in the sequence diagram as depicted on FIG. 3. Based on the parameters calculated or determined by the navigation system, for example, such as the time of arrival, the outside temperature, the interior temperature inside the vehicle, the driving time and the delay forecast (driving profile), the evaluator individually determines or calculates the deactivation time tE for switching off or reducing the power of each of the energy consumers. The energy consumers consume energy, and often have a slower response time or follow-up time, so that these energy consumers can be switched off within a predetermined time interval tE before a destination has been reached. In particular, the time interval tE is here selected in such a way as not to detract from the level of comfort afforded by the energy consumers or the safety of the vehicle.

As described above, one additional option would be to switch on or reactivate the energy consumers again, for example given unforeseeable delays or holdups. The advantage to such a system is that the power or fuel consumption can be reduced, in addition to which the battery life can be lengthened.

Even though the embodiments were described completely above based on preferred exemplary embodiments, it is not limited thereto, but can rather be modified in a variety of ways. Moreover, while at least one exemplary embodiment has been presented in the foregoing summary ad detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An energy management device for an energy consumer of a vehicle, comprising:
a receiver that is configured to record position data of the vehicle and other route data about an anticipated route progression for the vehicle to a predetermined destination using an onboard navigation system;
an evaluator that is configured to calculate a traveling time for the vehicle to reach the predetermined destination based on the position data and route data, and, based on the traveling time, calculate a deactivation time for switching off the energy consumer before the traveling time has expired; and
an actuator that is configured to switch off the energy consumer at the deactivation time.

2. The energy management device according to claim 1,
wherein the evaluator is further configured to determine the deactivation time based on one other parameter, and
wherein the one other parameter is a response time of the energy consumer, a sunlight incident on the vehicle, an interior temperature of the vehicle, an outside temperature of the vehicle, an occurrence of an actual state of the energy consumer.

3. The energy management device according to claim 2, wherein the evaluator is coupled with at least one light sensor, an interior temperature sensor, an outside temperature sensor, a rain sensor, a windshield wiper system or a temperature sensor in order to determine an actual temperature of the energy consumer.

4. The energy management device according to claim 1, further comprising a memory device that is coupled with the evaluator, and further configured to store the deactivation time for request of the deactivation time by the evaluator,
wherein the memory device is coupled with the energy management device.

5. The energy management device according to claim 1, wherein the evaluator is further configured to determine whether the vehicle will be delayed in reaching the predetermined destination based on the data of the onboard navigation system.

6. The energy management device according to claim 1, wherein the receiver is further configured to receive data from the energy consumer and further configured to determine whether the energy consumer is switched on based on the data from the energy consumer.

7. The energy management device according to claim 6, wherein the actuator is further configured to switch on a deactivated energy consumer when the evaluator determines that the vehicle will be late in arriving at the predetermined destination.

8. The energy management device according to claim 7, wherein the evaluator is further configured to determine a new deactivation time for a reactivated energy consumer.

9. A motor vehicle, comprising:
a navigation system;
an energy consumer;
an energy management device that is configured to manage the energy consumer of a vehicle, the energy management device comprising:
a receiver that is configured to record position data of the vehicle and other route data about an anticipated route progression for the vehicle to a predetermined destination using an onboard navigation system;
an evaluator that is configured to calculate a traveling time for the vehicle to reach the predetermined destination based on the position data and route data, and, based on the traveling time, calculate a deactivation time for switching off the energy consumer before the traveling time has expired; and
an actuator that is configured to switch off the energy consumer at the deactivation time.

10. The vehicle according to claim 9,
wherein the evaluator is further configured to determine the deactivation time based on one other parameter, and
wherein the one other parameter is a response time of the energy consumer, a sunlight incident on the vehicle, an interior temperature of the vehicle, an outside temperature of the vehicle, an actual state of the energy consumer.

11. The vehicle according to claim 9, wherein the evaluator is coupled with at least one light sensor, an interior temperature sensor, an outside temperature sensor, a rain sensor, a windshield wiper system or a temperature sensor in order to determine an actual temperature of the energy consumer.

12. The vehicle according to claim 9, further comprising a memory device that is coupled with the evaluator, and further configured to store the deactivation time for request of the deactivation time by the evaluator,
wherein the memory device is coupled with the energy management device.

13. The vehicle according to claim 9, wherein the evaluator is further configured to determine whether the vehicle will be delayed in reaching the predetermined destination based on the data of the navigation system.

14. The vehicle according to claim 9, wherein the receiver is further configured to receive data from the energy consumer and further configured to determine whether the energy consumer is switched on based on the data from the energy consumer.

15. The vehicle according to claim 14, wherein the actuator is further configured to switch on a deactivated energy consumer when the evaluator determines that the vehicle will be late in arriving at the predetermined destination.

16. The vehicle according to claim 15, wherein the evaluator is further configured to determine a new deactivation time for a reactivated energy consumer.

17. The motor vehicle according to claim 9, wherein the energy consumer is a seat heater.

18. The motor vehicle according to claim 9, wherein the motor vehicle is a hybrid vehicle.

19. The motor vehicle according to claim 9, wherein the motor vehicle is an electric vehicle.

20. A method for switching off an energy consumer of a vehicle, comprising:
recording position data of the vehicle and other route data about an anticipated route progression of the vehicle to a predetermined destination using an onboard navigation system;
calculating a traveling time it will take the vehicle to reach the predetermined destination based on the position data and route data;
calculating a deactivation time for switching off the energy consumer before the traveling time has expired based on the traveling time; and
switching off the energy consumer at the deactivation time.
